(19) United States
(12) Patent Application Publication
(10) Pub. No.: US 2015/0319223 A1
(43) Pub. Date: Nov. 5, 2015

(54) Delivering Content

(71) Applicant: Microsoft Corporation, Redmond, WA (US)

(72) Inventors: Koushik Deepak Narayana, San Francisco, CA (US); Shane M. Robbins, London (GB); Travis S. Bowie, Menlo Park, CA (US); Peter Vaughan Denny, London (GB)

(21) Appl. No.: 14/268,924

(22) Filed: May 2, 2014

(51) Int. Cl. H04L 29/08; H04L 29/06; H04L 12/58

(52) U.S. Cl. CPC H04L 67/10; H04L 67/18; H04L 51/04; H04L 65/403

(57) ABSTRACT

Disclosed is a method of delivering targeted content to users of a communication system comprises receiving notification data of a communication event conducted over a communication network of the communication system between at least a first and a second user of the communication system, the notification data identifying the second user and conveying information pertaining to the first user. The method further comprises selecting content for transmission to the identified second user based on the information pertaining to the first user and transmitting the selected content to a user device associated with the identified second user for delivery to the second user.

### BACKGROUND

Communication systems allow users to communicate with each other over a communication network e.g. by conducting a call over the network. The network may be, for example, the Internet or public switched telephone network (PSTN). During a call, audio and/or video signals can be transmitted between nodes of the network, thereby allowing users to transmit and receive audio data (such as speech) and/or video data and/or (such as webcam video) to each other in a communication session over the communication network.

Such communication systems include Voice or Video over Internet protocol (VoIP) systems. To use a VoIP system, a user installs and executes client software on a user device. The client software sets up VoIP connections as well as providing other functions such as registration and user authentication. In addition to voice communication, the client may also set up connections for communication modes, for instance to provide instant messaging (“IM”), SMS messaging, file transfer and voicemail services to users.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

According to a first aspect, a method of delivering targeted content to users of a communication system comprises receiving notification data of a communication event conducted over a communication network of the communication system between at least a first and a second user of the communication system, the notification data identifying the second user and conveying information pertaining to the first user. The method further comprises selecting content for transmission to the identified second user based on the information pertaining to the first user and transmitting the selected content to a user device associated with the identified second user for delivery to the second user.

According to a second aspect, a method of delivering targeted content to users of a communication system comprises accessing record data of at least one past communication event conducted over a communication network of the communication system, the at least one past communication event between at least a first user and a second user of the communication system. The method further comprises determining from the record data a historical location of at least one of the first and second users at a past point in time during the past communication event. The method further comprises selecting content for transmission to at least the second user based on the determined historical location. The method further comprises detecting current activity in the communication system by the second user at a current point in time, the current activity at a user device associated with the second user. The method further comprises, responsive to detecting the current activity, transmitting the selected content to the user device for delivery to the second user.

### BRIEF DESCRIPTION OF FIGURES

For a better understanding of the subject matter and to show how the same may be carried into effect, reference will now be made by way of example only to the following drawings in which:

FIG. 1 is a schematic illustration of a communication system;

FIG. 2 is a schematic block-diagram of a user device;

FIG. 3 is a schematic block-diagram of a server;

FIG. 4 is a flow chart for a method of delivering targeted content to users of a communication system;

FIG. 5 is a high-level overview of functionality implemented within a communication system;

FIG. 6A is a flow chart for a method of delivering targeted content to users based on location data;

FIG. 6B illustrates interactions of components of a communication system;

FIG. 7A is a schematic illustration of a client graphical user interface during a call;

FIG. 7B is a schematic illustration of a client user interface during a user-consent procedure.

### DETAILED DESCRIPTION

Embodiments will now be described by way of example only.

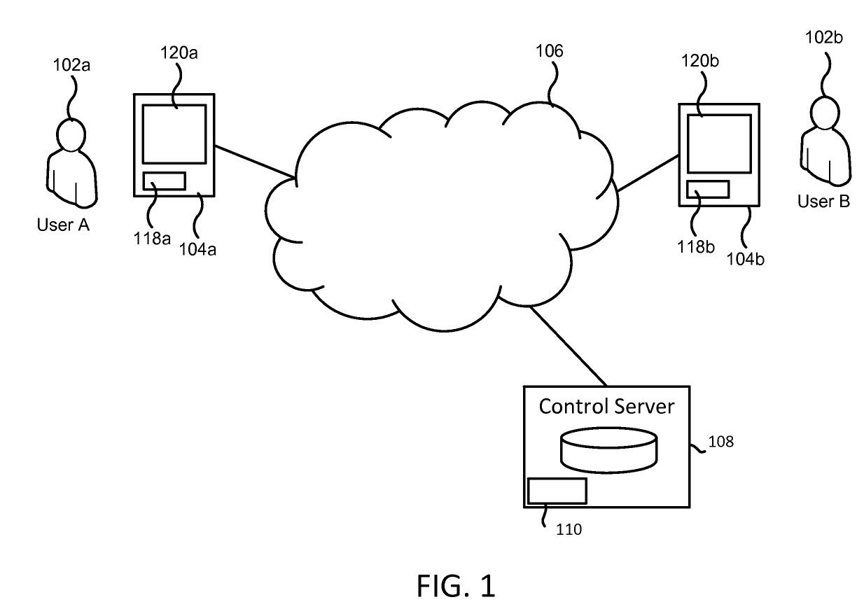

Reference is first made to FIG. 1, which illustrates a communication system 100 which is a packet-based communication system in this embodiment but which may not be packet-based in other embodiments. A first user 102a of the communication system (User A or “Alice”) operates a user device 104a, which is shown connected to a communications network 106. The communications network 106 may for example be the Internet. The user device 104a is arranged to receive information from and output information to the user 102a of the device. The user device 104a comprises a display such as a screen 120a for outputting information to the user 102a.

The user device 104a is running a communication client 118a, provided by a software provider associated with the communication system 100. The communication client 108a is a software program executed on a local processor in the user device 104a which allows the user device 104a to establish communication events—such as audio calls, video calls, instant messaging communication sessions, etc. —over the network 106.

FIG. 1 also shows a second user 102b (User B or “Bob”) who has a user device 104b which executes a client 118b in order to communicate over the network 106 in the same way that the user device 104a executes the client 118a to communicate over the network 106, and which has a similar display 120b. Therefore users A and B (102a and 102b) can communicate with each other over the communications network 106. There may be more users connected to the communications network 106, but for clarity only the two users 102a and 102b are shown connected to the network 106 in FIG. 1.

Note that in alternative embodiments, the user devices 104a and/or 104b can connect to the communication network 106 via additional intermediate networks not shown in FIG. 1. For example, if one of the user devices is a mobile device, then it can connect to the communication network 106 via a cellular mobile network (not shown in FIG. 1), for example a GSM or UMTS network.

Communication events between Alice and Bob can be established using the clients 118a, 118b in various ways. For instance, a call can be established by one of Alice and Bob instigating a call invitation to the other (either directly or indirectly by way of an intermediary network entity such as a server or controller) which the other accepts, and can be terminated by one of Alice and Bob electing to end the call at their client. An instant messaging communication session is established by one of Alice and Bob instigating an initial instant message to the other and may be terminated e.g. upon Alice or Bob logging off and/or after a predetermined period of inactivity.

Each communication client instance 118a, 118b has a log in/authentication facility which associates the user devices 104a, 104b with their respective users 102a, 102b e.g. by the user entering a username and password at the client and which is verified against user account data stored at a server (or similar) of the communication system 100 to as part of an authentication procedure. Users can have communication client instances running on other devices associated with the same log in/registration details.

In the case where the same user, having a particular username, can be simultaneously logged in to multiple instances of the same client application on different devices, a server (or similar) is arranged to map the username (user ID) to all of those multiple instances but also to map a separate sub-identifier (sub-ID) to each particular individual instance. Thus the communication system is capable of distinguishing between the different instances whilst still maintaining a consistent identity for the user within the communication system.

User 102a (Alice) is logged-in (authenticated) at client 118a of device 104a as “User A”. User 102b (Bob) is logged-in (authenticated) at client 118b of device 104b as “User B”.

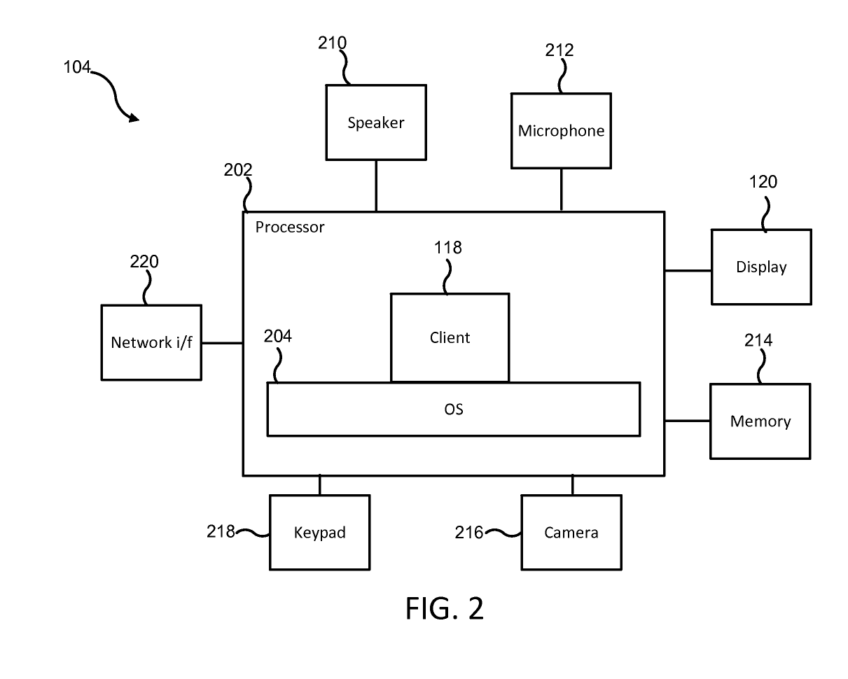

FIG. 2 illustrates a detailed view of a user device 104 (e.g. 104a, 104b) on which is executed a communication client instance 118 (e.g. 118a, 118b). The user device 104 comprises a processor 202 in the form of one or more central processing units (“CPUs”), to which is connected a memory 214 for storing data, an output device in the form of a display 120 (e.g. 120a, 120b), having an available display area, such as a screen, input devices such as a keypad (or a keyboard) 218 and a camera 216 for capturing video data. The display 120 may comprise a touchscreen for inputting data to the processor 202 and thus also constitute an input device of the user device 104. An output audio device 210 (e.g. a speaker) and an input audio device 212 (e.g. a microphone) are connected to the CPU 202. The display 120, keypad 218, camera 216, output audio device 210 and input audio device 212 may be integrated into the user device 104, or one or more of the display 120, the keypad 218, the camera 216, the output audio device 210 and the input audio device 212 may not be integrated into the user device 104 and may be connected to the CPU 202 via respective interfaces. One example of such an interface is a USB interface. The CPU 202 is connected to a network interface 220 such as a modem for communication with the communications network 106 for communicating over the communication system 100. The network interface 220 may or may not be integrated into the user device 104 as shown in FIG. 2.

The user device 104 may be, for example, a mobile phone (e.g. smartphone), a personal computer (“PC”) (including, for example, Windows™, Mac OS™ and Linux™ PCs), a gaming device, tablet computing device or other embedded device able to connect to the network 106.

FIG. 2 also illustrates an operating system (“OS”) 204 executed on the CPU 202. The operating system 204 manages hardware resources of the computer and handles data being transmitted to and from the network via the network interface 220. The client 118 is shown running on top of the OS 204.

The client 118 has a user interface for presenting information to and receiving information from a user of the user device 104. The user interface comprises a graphical user interface for displaying information in the available area of the display 120.

Returning to FIG. 1, also shown is a computer device such as a server 108 which is connected to the network 106 and forms part of the communication system 100. The server 108 executes server code 110.

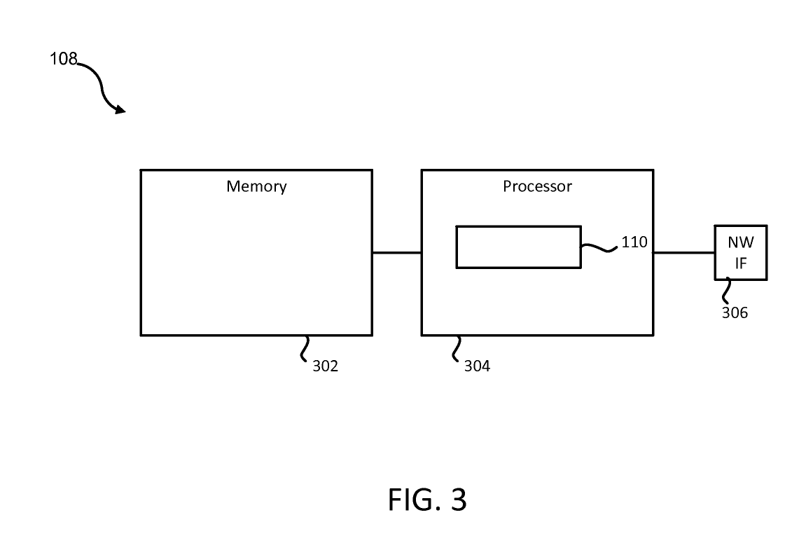

FIG. 3 is a detailed view of the server 110. The server 110 comprises at least one processor 304, which executes the server code 110. Connected to the processor 304 are computer storage (memory) 302 for storing data and a network interface 306 for connecting to the network 106. Although shown as a single computer device, the functionality of the server 110 may alternatively be distributed across multiple computer devices, e.g. multiple servers. That is, the functionality of the server 110 may be implemented by a computer system comprising one or computer devices and one or more processors.

As explained in more detail below, the server 110 collects information about communication events conducted between users of the communication system 100 where their consent has been given to do so, including communication events between the first and second users 102a, 102b. This collected information is then used to select targeted content, for transmission to users, that is most likely to be of interest to those users.

The disclosure recognizes that, when two or more users elect to participate in a communication event with each other, such as a call or Instant Messaging (IM) conversation, that indicates that those two or more users have some form of relationship with one another. That is, the fact that those two or more users actively chose to participate in the communication event suggests that those users have some form of personal relationship with one another.

Thus, when at least first and second users choose to participate in a communication event, it can be inferred on that basis that information that is known about, say, the first user might also be relevant to, say, the second user. For example, if a geographic location of the first user (such as a country or similar geolocation in which they are currently located) is known, it can be inferred that that geographic location might be of interest to the second user. As another example, if some topic is known to be of interest to the first user, it can be inferred that that topic might also be of interest to the second user. If the second user frequently participates in communication events with the first user, such inferences can be made with a reasonably high level of statistically certainty.

It should be noted that the term “geographic location” as used herein can refer to any level of geographic granularity e.g. country, be one or many continents (e.g. Europe), regions (e.g. Western Europe), countries (e.g. Germany), territories/state (e.g. Bavaria), counties, cities/DMAs (i.e. Munich), Zip/postal codes (e.g. 80331).

Similarly, if the second user frequently participates with multiple users who have something in common (for instance, who are geographically collocated e.g. in the same county or other geolocation, or who all share one or more common topics of interest), it can be inferred with a reasonably high level of statistical certainty that whatever it is that those users have in common might be a source of interest to the second user. For instance, if the second user is frequently participating in communication events with users in the same country, it can be reasonably inferred that that country might be of interest to the second user; if the second user if frequently conferring with users who all share some common topic of interest, it can be reasonably inferred that the second user might also be interested in that topic.

Thus, by using information about communication event(s) that the second user has participated in with other users, it is possible to deliver an enhanced user experience to the second user by delivering content to that user that is tailored to their inferred interests, tastes etc.

For example, the disclosed techniques can be used to target content, such as advertising content, to users based on their historical “calling corridors”. As an example, content can be targeted to users who have historically communicated, either by chat (IM) or calls, to and from geographic regions (e.g. California<->India, US<->UK, Poland<->Germany). In embodiments, the source and/or destination of a conversation (communication event) is identified and this information used to target content, such as advertisements, in the future. For example, where a user has historically communicated from region Y to region X (“Y<->X” calling corridor), advertising content that comprises information about travel opportunities from Y to X, e.g. relating to a deal on aeroplane tickets from Y to X, may be selected on that basis for transmission to that user.

The disclosure also recognizes that, when two users participate in a communication event over a communication system (e.g. call or chat), this provides a good opportunity for the operator of that communication system to collect information about those users with their consent, such as location data of one or both of those users, in an efficient manner as information about communication events is typically already logged e.g. in the form of a conversation history held in the communication system and accessible to the user from different user devices. That is, collection of such data can be reality incorporated into existing mechanisms for logging information about communication events.

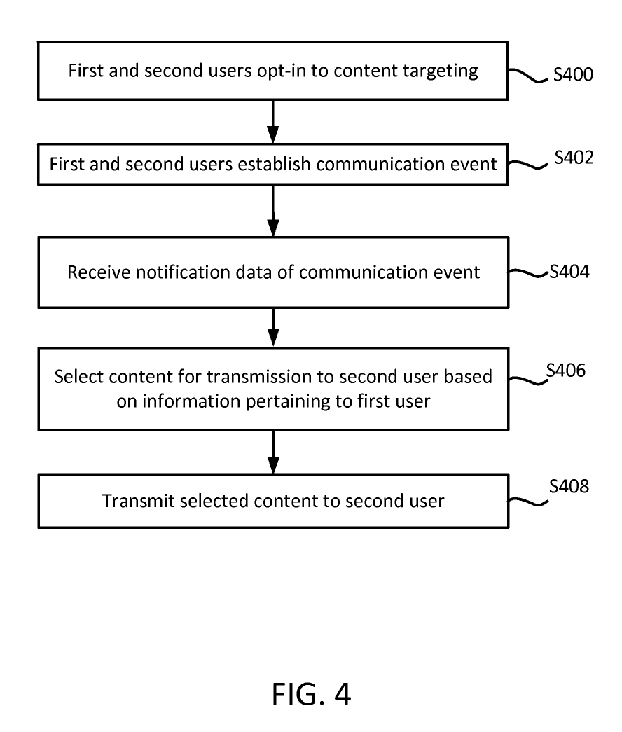

A method of delivering targeted content to users of a communication system 100 will now be described with reference to FIG. 4, which is a flow-chart for the method. The method is a computer-implemented method in this embodiment, implemented by the control code 110 when executed at the server 108.

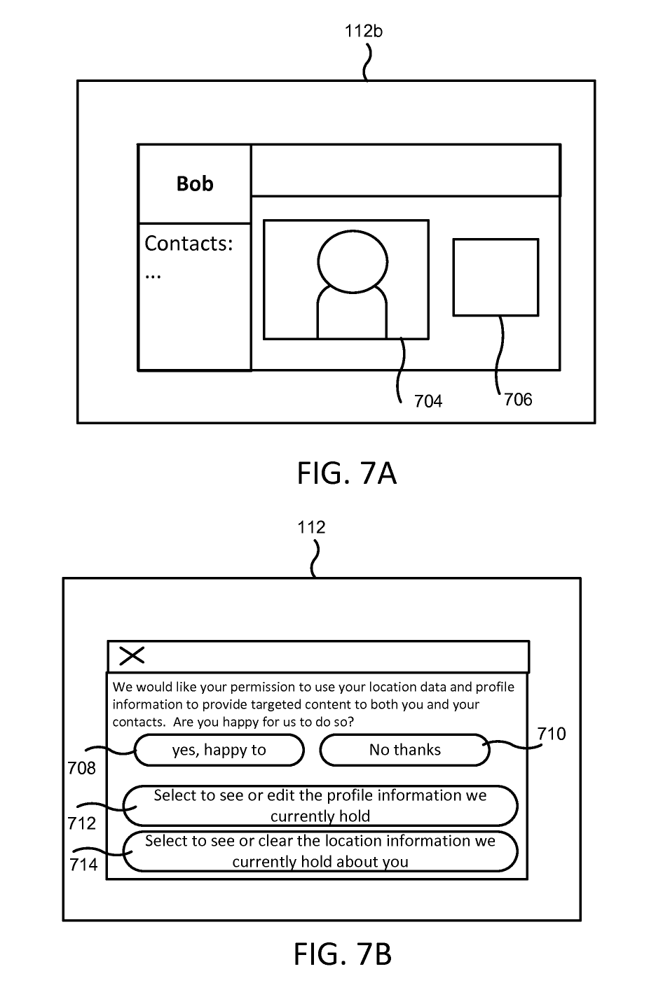

At step S400, the first and second users 102a, 102b (Alice and Bob) opt-in to the content targeting procedure. For instance, in embodiments, a dialogue box as illustrated in FIG. 7A is presented via their client user interfaces. The dialogue is, for instance, displayed when Alice and Bob first open their clients after initially installing them on their user devices, and may be accessible through e.g. touchscreen menus or by way of a suitable swipe or gesture command. The dialogue informs users of the type of data that the client wishes to use for the purposes of targeting content to the user and their contacts. The user can select either an opt-in in option 708 or an opt-out option 710. The dialogue also has a selectable option 712 for the user to see and edit/remove profile information that is current held about them in the system 100, and a selectable option 714 to see what location information is currently held about them if any (which will only be the case if they have previously selected the opt in option 710) in the system 100, and to permanently destroy that information if they so desire at any time.

At step S402, assuming the first and second users have selection option 710 procedure, the first and second users 102a, 102b (Alice and Bob) establish a communication event over the communication network 106 of the communication system 100. The communication event is established by the users using their respective clients 118a, 118b and may or may not involve other users in addition to the first and second users. The communication event may, for instance, be a call or instant messaging conversation.

At step S404, the server 108 receives notification data of the communication event. The notification data notifies the recipient of the notification data (here, the server 108) of the communication event between the first and second users, and thus constitutes a notification of the communication event. The notification data also identifies at least the second user and also conveys information pertaining to the first user. For example, the notification data may comprise one or more notification messages transmitted by one or both of the clients 118a, 118b. The server 108 thus knows from the notification data that the first and second users have decided to participate in a communication event. For example, the notification data may include user identifiers of the users such as their usernames in the communication system 100, their network addresses e.g. IP (“Internet Protocol”) addresses etc., or anonymized versions thereof.

The information about the first user that is conveyed by the notification data may take a number of forms—e.g. the notification data may also identify the first user, and/or convey a geographic location associated with the first user, and/or convey some other information pertaining to the first user e.g. by identifying a business entity associated with the first user (for instance, the notification data may comprise a telephone number used by the first user to participate in the communication event which is known to be a telephone number of, and which thus identifies, a particular business entity e.g. a hotel in Rome).

In some embodiments, the method of FIG. 4 comprises accessing user data (e.g. personal data) of the first user 102a. The user data conveys information about the first user and is held in the computer storage 302 of the server 108.

Some or all of the user data could be received with (e.g. as part of) the notification data.

Alternatively or additionally, some or all of the user data could held in an accessible location (accessible to the server 108) in memory 302 (or some other remote storage location accessible to the server 108), having been stored in the accessible location prior to receiving the notification data rather than being received with the notification data. In such embodiments, the notification data identifies the first user (e.g. comprises a user identifier of the first user) thereby enabling the exiting user data of the first user to be identified for this purpose (e.g. the user data of the first user may be stored in association with the user identifier of the first user, and thereby matched to the received user identifier of the first user).

That is, in embodiments, user data of the first user is accessed. At least a first part of that user data may be received in the notification data and/or the notification data may identify a location in computer storage at which at least part of that user data is stored.

In some embodiments, the user data comprises location data that conveys a geographic location associated with the first user 102a.

The location data may, for instance, be received with (e.g. as part of) the notification data itself, and convey a geographic location of the first user at a point in time during the communication event to which the received notification data relates. In this case, the location data is accessed by extracting that location data from the notification data.

Alternatively or additionally, the location data may comprise historical location data that is not received as part of the notification data and which is held in memory 302. For example, the historical location data may convey geographic location(s) of that first user during other past communication event(s), which may be used in addition to any location data received as part of the notification data for the communication event established at step S402 and/or some other geographic location associated with the first user, such as a geographic location that the first user has explicitly indicated that they are associated with (e.g. in creating a user profile in the system 100) i.e. a declared location of that user indicated in the location data.

The location data may convey the geographic location directly e.g. in terms of a country code or latitude-longitude (lat-long) coordinates e.g. obtained using a GPS (“Global Positioning System”) at the first user's device 104a and transmitted to the server 108. Alternatively or additionally, the location data may convey the geographic location indirectly. For example, the location data could comprise an IP address of the first user's device 104a, based on which a reverse IP lookup can be performed to determine a location associated with that IP address and/or a telephone (phone) number e.g. of the calling or called party during the communication event (e.g. as identified by a country code, area code, and phone number string).

A user's geographic location can therefore be determined in a variety of ways, depending on the nature of the location data, including 1) from a network (e.g. IP) address (as detected in doing a reverse IP look-up or lat/long lookup); 2) from a phone number; 3) from a declared location (e.g. as specified by the user when they set up their user account within the system 100) etc.

In other embodiment, the user data alternatively or additionally comprises user model data from a user model of the first user held in the computer storage 302. The user model is a collection of user-profile data associated with the first user, some or all of which may be accessible to user devices (e.g. 104b) in the communication system 100 for display at those user devices to other users (e.g. the second user) in the form of a user profile, and which is e.g. created by the first user in creating the user profile within the system 100.

For instance, in some embodiments, the user model comprises preference data which conveys information about the first user's preferences, tastes etc. For example, the user preference data may identify one or more topics of interest to the first user (such as music, sport, food, knitting etc.). These could be topics that the first user has, at some point, expressed an interest in e.g. by selecting these topics as being of interest when creating or updating their user profile, thereby including topic identifiers of those topic(s) in their user model.

At step S406, content for transmission to the identified second user (as identified in the received notification data i.e. Bob) is selected based on the information pertaining to the first user (i.e. Alice) conveyed by the notification data (e.g. based on the user data of the first user). That is, content to be transmitted to Bob is selected based on knowledge of Alice, on the basis that information about Alice is likely to be relevant to Bob because Alice and Bob have actively decided to participate in a communication event with one another and can thus be assumed to have some form of relationship (e.g. personal or business relationship) with one another.

For example, in embodiments where the user data conveys a geographic location associated with Alice, the content may be selected based on that geographic location e.g. content that is relevant to that geographic location (e.g. because it conveys information about that geographic location) may be selected on the basis that Bob might have some interest in Alice's location.

Where the user data includes preference data relating to Alice's preferences, content relevant to those preferences may be selected on the basis that Bob is also likely to share at least some of those preferences e.g. if Alice has expressed an interest in knitting that is identified in her user model, content related to wool may be selected for transmission to Bob on the assumption that Bob may also share an interest in knitting and therefore be amenable to receiving wool-related content.

In addition to being based on the information pertaining to Alice, the selection may be further based on information pertaining to Bob e.g. user data of Bob (which conveys information about Bob in the same way that user data about Alice can convey information about Alice—see above). For example, the user data of Bob may convey a geographic location associated with Bob in the same way that the user data of Alice can convey a geographic location associated with Alice (see above). In this case, the content for transmission to Bob can be selected based on the geographic locations associated with both Alice and Bob. For example, if Bob is associated with location Y (e.g. the USA) and Alice is associated with location X (e.g. Brazil), content can be selected that is relevant to both of those locations e.g. an advert for travel from Bob's location Y (e.g. the USA) to Alice's location X (e.g. Brazil).

In some embodiments, the selection step S406 may based on information about other communication events between Alice and bob held at the server 108, for example record data recording one or more other historical communication events that Alice and Bob have participated in over an interval of time (considered duration). For example, if Alice and Bob have communicated frequently with one another over the interval of time, this can be taken as an indication that information about Alice is more likely to also be relevant to Bob than if they communicated infrequently. Thus, the step of selecting content for transmission to Bob based on the information pertaining to Alice may be conditional on (i.e. only performed) if Alice and Bob have communicated with one another on a number of occasions over the interval of time (e.g. approximately the last 30 days) that is at least a threshold number of times (e.g. at least 3 times). That is, the step of selecting may be conditional on there having been more than the threshold number of separate communication events between Alice and Bob over the interval of time. That is, the step of selecting content may be conditional on the first and second users having participated in communication events with one another at least a threshold number of times at past points in time that are within a considered duration (e.g. the last approx. 30 days). In various embodiments, the content for transmission to the second user identified in the notification data (i.e. Bob) may be selected based on a geographic location conveyed by the notification data and associated with the first user, and/or based on a user identifier of the first user, received in the notification data, that identifies the first user. Alternatively or additionally, the information pertaining to the first user that is conveyed by the notification data may be information about a business entity associated with the first user, such as information about the identity and/or the nature of the business entity e.g. it may comprise a business telephone number, of a business entity, which the first user used to participate in the communication event. Content (e.g. advertising content) can then be targeted to users who have called, say, businesses in certain locations in the past (e.g. if the second user has called hotels in Rome—that is, if the conveyed information is e.g. that the first user participated in the call using a hotel system of a hotel in Rome of which their user device 104a forms part—advertisements could be targeted to those users showing flights to Rome, activities to do in Rome, etc.).

In some embodiments, the notification data conveys whether or not Bob instigated the communication event, and the content is selected based on whether or not Bob instigated the communication event. For example, for a call, the content could be selected in dependence on whether or not Bob placed that call to the other(s) (i.e. whether Bob is a caller or callee) for an IM communication, whether or not Bob user initiated the IM communication etc.

Pieces of content are stored at the server 108, each in association with one or more content identifiers which characterize the content and enable the selection. The selection can then be performed by matching the information pertaining to user(s) (or information derived therefrom) to the identifiers associated with a particular piece of content. For example, a particular piece of content may be stored in association with one or more location identifiers of geographic locations and/or one or more topic identifiers of topics to which that piece of content relates and/or one more user attribute identifiers (e.g. of age groups, genders etc.) to which that content relates etc., and that piece of content selected by matching geographic location(s) associated with the user(s) to those location identifier(s) and/or topics associated with the user(s) (e.g. from their user model(s)) to those topic identifier(s) and/or attributes of the user(s) (e.g. identified in their user model data) to those user attribute identifiers.

A piece of content may be characterized by a set of one or more content identifiers e.g. to enable various forms of targeting to be combined. For instance, if an advertiser wanted to a piece of content to, say, males, age 18-24, who have called or instant messaged Brazil, that piece of content would be stored in association with, say, a gender identifier identifying that content as being for males, an age identifier identifying that content as being for ages 18-24, and an interest location identifier identifying brazil as an interest location to which that content relates. The content is then selected by matching, say, user data of the second (targeted) user to the gender and age identifiers, and the user data of the other, first user to the interest location identifier.

The selected content may be advertising content that is transmitted from an ad server.

At step S408, the selected content is transmitted (e.g. form an ad server) to the user device 104b associated with the identified second user 102b (i.e. Bob) for delivery to Bob.

In some embodiments, the transmission of the selected content (S408) may be in response to receiving the notification data of the communication event established at step S602. For instance, the selected content may be transmitted to Bob whilst the communication event with Alice is still ongoing and may be displayed via the client graphical user interface whilst the communication event is in progress. In this case, the method of FIG. 4 is performed in substantially real-time (e.g. with it taking less than a few seconds to complete S402-S408). A particular example would be selecting content based on current geographic locations of Bob and/or Alice at a current point in time during that communication event, as conveyed in the received notification data, and transmitting that selected content to Bob to be displayed at substantially that current point in time (e.g. within a few second thereof) e.g. whilst the communication event is still in progress.

In other embodiments, the notification data received at step S404 may be stored as historical notification data for use in targeting content to Bob in the future and/or the accessing step may be part of a step of generating historical record data in memory 302 for future use e.g. to generate record data that associates a user identifier of Bob with the information pertaining to Alice (or other information derived therefrom) for future use. The content can then be selected (at S406) based on the stored historical notification data and/or the previously-generated historical record data which is accessed in memory 302, and transmitted to Bob at any desired later point in time. A particular example would be selecting content based on historical locations of Alice and/or Bob at past point(s) in time during past communication event(s), as determined from the stored historical notification data and/or stored historical record data, and transmitting the selected content to Bob at a current point in time e.g. responsive to detecting current activity at Bob's user device 104b at the current point in time (for instance, responsive to Bob's user device 104b transmitting a request for that content to the server 108 instigated by Bob's client application 118b, or which is pushed to Bob's client response to Bob's client subscribing to a push channel for receiving that content).

In particular embodiments, notification data of various communication events in which Bob has participated over a past interval of time (considered duration e.g. approximately one month) is collated to generate historical collated record data. The collated record data associates a user identifier of Bob with historical geographic locations of both Bob and of other participants in those communication events (e.g. at least Alice) at past points in time during those communication events, those historical locations having been conveyed by location data previously-received with the notification data of the various past communication events (which is accessed in generating the collated record data). Content is then selected for transmission to Bob based on this collated record data, and transmitted to Bob in response to detecting current activity at a current point in time at Bob's user device.

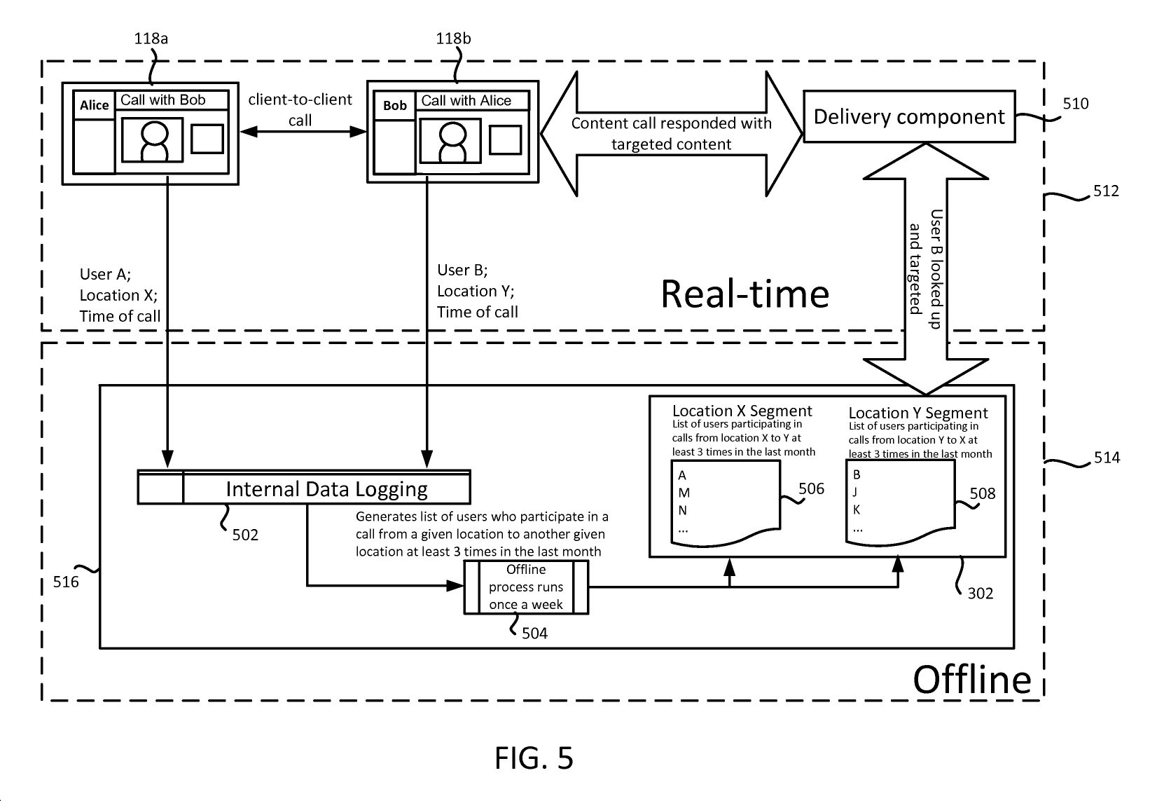

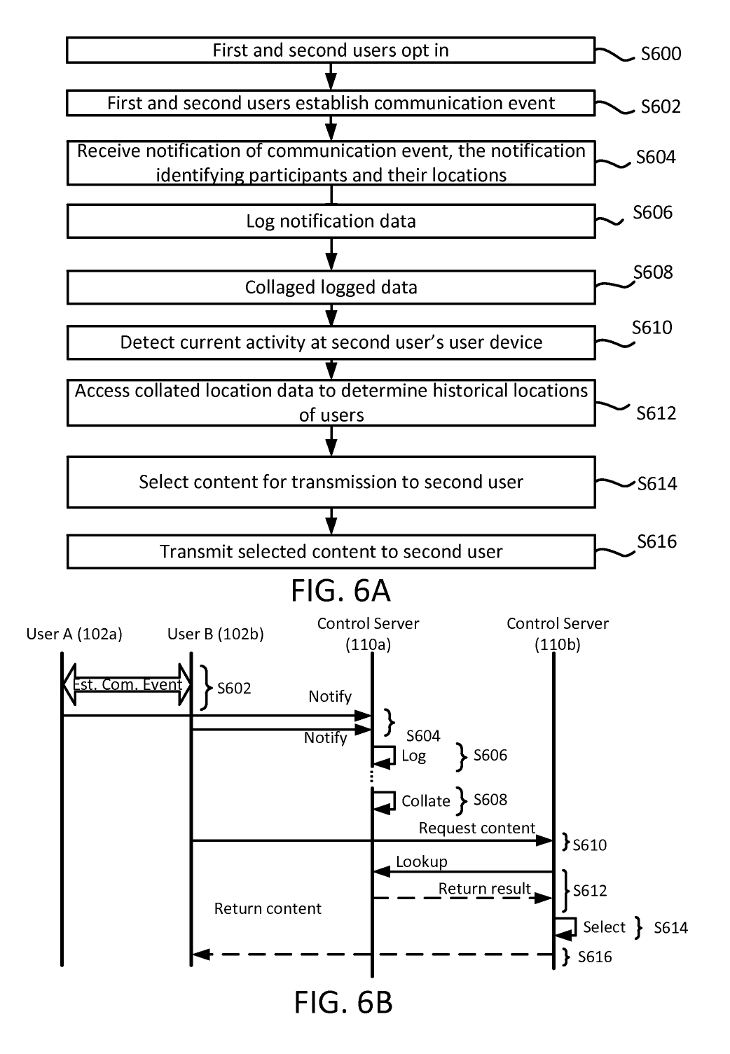

These particular embodiments, in which location data specifically is used to target content to users of the communication system 100, will now be described with reference to FIGS. 5, 6A and 6B.

FIG. 5 is a high-level schematic overview of functionality of the system 100 in these particular embodiments and shows a data logging component 502 and a data collation component 504 which represent a data logging process and a data collation process respectively. FIG. 5 also shows a content delivery component 510 for selecting and transmitted content to the user devices 104a, 104b (specifically, to the clients 110a, 110b). The components 502, 504, 510 are functional blocks representing functionality that is implemented by executing the code 110 on the processor 304 of the server 108.

The internal data logging component 502 has first and second inputs connected to receive a first piece of notification data from the first client 118a and a second piece of notification data from the second client 118b respectively. The data collation component 504 has an output connected to an input of the data logging component 502 and a plurality of outputs, each supplying a respective “location segment” 506, 508 (see below) which are held in memory 302. The data logging component 502, data collation component 504 and the memory 302 constitute a record system 516 which generates and holds (collated) record data, in the form of the location segments 506, 508, of historical communication events conducted between users at past points in time.

The content delivery component can access the record system 516 and in particular can access the location segments 506, 508 in memory 302 as denoted by the vertical two-way arrow in FIG. 5. The content delivery component can communicate with the clients 118a, 118b and in particular can detect activity at Bob's client 118b and deliver content to Bob's client 118b as denoted by the horizontal two-way arrow in FIG. 5.

The dashed box labelled 512 represents processes which are performed in real-time (that is, on-line processes performed on-the-fly), including the accessing of the location segments by the delivery component 510 and the establishment of a communication event between Alice and Bob; in contrast, the dashed box labelled 514 represents processes that are performed off-line (e.g. weekly, monthly etc.) such as the data logging and data collating.

A method of delivering targeted content to users based on location data will now be described with references to FIG. 6A (which is a flow-chart for the method) and FIG. 6B (which schematically illustrates interactions between components of the system 100 in performing the steps of that method).

At step S600, the first and second users opt in to the targeting process (equivalent to S400 above).

At step S602, the first and second users 102a, 102b (Alice and Bob) establish a communication event over the communication network 106 of the communication system 100. The communication event is established by the users using their respective clients 118a, 118b and may or may not involve other users in addition to the first and second users. The communication event may, for instance, be a call or instant messaging communication session, as discussed.

Alice and Bobs' clients 118a and 118b transmit first and second pieces of notification data respectively to the record system 516, which are received at step S604.

The first piece of notification data from Alice's client 108a comprises a user identifier of the first user (Alice), first location data conveying a location of Alice during the communication event (directly e.g. in the form or longitude-latitude coordinates or indirectly e.g. in the form of an IP address for which a reverse lookup can be performed to determine Alice's location—see above), and a first time code of a time associated with the communication event e.g. a time at which the communication event was established.

The second piece of notification data comprises a user identifier of the second user (Bob), second location data conveying a geographic location of Bob during the communication event (directly e.g. in the form or longitude-latitude coordinates or indirectly e.g. in the form of an IP address for which a reverse lookup can be performed to determine Bob's location—see above), and a second time code of the time associated with the communication event e.g. a time at which the communication event was established.

The first and second pieces of notification data both relate to the same communication event in between Alice and Bob (that is, the same communication event in which Alice and Bob are both participating, established at S602). The first and second time codes match one another i.e. the first and second time codes are time codes of the same time.

Together, the first and second pieces of notification constitute notification data that conveys the fact that the communication event established at S602 took place between at least two participants (and thus constitutes a notification of the communication event) and identifies those participants as Alice and Bob. At step S606, the notification data is stored (logged) in memory 302. The logged notification data is held in memory for at least a predetermined amount of time (e.g. about 1 month). Where the location data received in the first and second pieces of notification data only indirectly conveys the locations of the communication event participants (e.g. by way of an IP address), those location may be determined (e.g. by performing a reverse IP lookup) and the location data augmented or replaced with the actual determined location before it is logged so that the logged data contains actual locations.

At Step S608, a collation process is performed to collate previously-logged notification data, thereby generating collated record data. The collation process is performed periodically (e.g. about once a week).

The collation process collates all the notification data logged over a considered duration (e.g. over approximately the last, i.e. most recent, 30 days) to generate a plurality of location segments. Over that duration, other notification data of other communication events between at least two users and comprising equivalent location data may also be received and logged. This could include communication events in which Alice and Bob are participants and/or communication events in which Bob is a participant but Alice is not a participant.

Each location segment is for a respective “communication event corridor”, that communication event corridor being a pair of associated locations (Y,X) (equivalently denoted herein as “Y<->X”), and comprises a set of user identifiers of users who have participated in communication events from location X to location Y. It should be noted that the location segment for (Y,X) is different from the location segment (X,Y)—the former being users who have participated in communication events form Y to X e.g. Bob, the latter being users who have participated in communication events from X to Y e.g. Alice). The set may be a restricted set of such users—in this example, users are only included in that set if they have participated in communication events from X to Y (with the same or different other participants) more than a threshold number of times N (e.g. N=3) over the considered duration. The location segments constitute collated record data of communication events between at least two participants, from which historical locations of participants in those communication events at past points in time during those communication events can be determined.

In other words, both a source and destination of a communication may be used to qualify a corridor. For instance, it may be known that a corridor US<->Mexico exists, but it can also be useful to know the source of the communication and the destination of the communication (US->Mexico) to be able to deliver targeted content (e.g. ads). For example, a money transfer company may want to show ads in English to those users in the US who are sending IMs or calling users in Mexico as a means to drive awareness of their service or facilitate money transfers. That same company may have no interest in targeting Spanish ads to users in Mexico who are sending IMs or calling users in the US (although some other company might). That's one reason a source and destination for each communication is useful, as it enables a form of behavioural targeting (e.g. US->Mexico or us users who have communicated to users in Mexico).

Where content is selected based on calling corridors, pieces of content are stored at the server, each in association with one or more calling corridor identifiers. A calling corridor identifier comprises, for instance, a pair of location identifiers idX,idY where idY is a location identifier of an associated target location (e.g. location Y or related location) and idX is a location identifier of an associated interest location (e.g. location X or related location)—that piece of content is selected by matching the second user's (and not the first user's) associated geographic location to the target location identifier idY (the “targeted” user being the second user to whom that piece of content is to be transmitted) and the first user's (and not the second user's) associated location to the interest location identifier idX (the first user's location being of possible “interest” to the second, targeted user). The content may also be selected depending on whether or not the second user instigated the communication event e.g. to only target users who have placed (resp. received) calls or transmitted (resp. received) IMs from the US to Mexico.

In general, a piece of content may be stored in association with a calling corridor identifier which conveys a target location (to be matched to the second, targeted user's associated location but not to the first user's location) and at least on interest destination (to be matched to the first user's associated location but not to the second, targeted user's location). The content may also be stored in association with information that conveys whether or not that content is specific to users who have, say, instigated communication events, e.g. placed a call, transmitted one or more IM(s) etc., from the source location (resp. who have received communication events e.g. taken a call placed by another user, received one or more IM(s) etc.), and that content selected e.g. only if the second user instigated (resp. received) the communication event from the target location to the location of interest.

It will thus be appreciated that the associated target and destination locations of a calling corridor amount to more than simply a pair of geographic locations as they also define a ‘directionality’ of that corridor (e.g. US->Mexico as opposed to Mexico->US). This can be useful for ensuring that appropriate content is selected (e.g. English-language advertising content relating to money transfers from the US to Mexico for the US->Mexico corridor, which would not be appropriate for the Mexico->US corridor—see above).

As denoted by the dotted line separating steps S606 and S608 in FIG. 6B, the collation process may be performed some time (e.g. up to about 30 days) after the record data is received at step S606.

At step S610, current activity at Bob's user device 104b is detected at a current point in time. The current point in time may be up to about 1 month after the notification of the communication event received at S604.

The current activity may for instance be Bob's user device 104b transmitting a request for that content to the server 108 instigated by Bob's client application 118b (e.g. in response to Bob logging on at his client, in response to Bob establishing a communication event, or periodically), or Bob's client subscribing to a push channel which can be used to transmit targeted content to Bob.

At step S612, the location segments are accessed in memory 302 to identify at least one location segment in which Bob is identified, and to thereby determine its associated corridor (Y,X) (Y being Bob's historical location in at least N past communication events, X being a historical location of other participant(s) in those communication event e.g. Alice). The fact that Bob is identified in that location segment means that Bob has participated in at least three communication events from location X to location Y, which may for instance be a historical location of Alice, in the last e.g. 1 month).

At step S614, content is selected for content to Bob based on the identified calling corridor (Y,X) associated with the at least one location segment in which. For instance, the content may be advertising content relating to travel opportunities for travel from location X (where Bob is likely to be currently) to location Y (where it can be assumed that Bob knows one or more people, and knows them well enough to have communicated with them e.g. at least three times in the last month).

Because of the nature of the collated record data, the step of selecting is conditional on Bob having communicated with one or more users in the determined historical location at least a threshold number of times (e.g. N=3) at past points in time within the considered duration (e.g. the approx. 30 days) e.g. Bob must, say, have communicated with Alice at least 3 times, or with Alice and one or more other users in substantially the same location as Alice at least 3 times in total (e.g. twice with Alice, and once with another user in the same location as Alice e.g. in the same country or other geolocation).

In embodiments, the selected content is advertising content and the delivery component 510 in FIG. 5 may be implemented by one or more ad servers for delivering advertisements to users. Conversation data in communication events (calls, IM conversations) is analyzed to determine e.g. the geographic location of the originator and the geographic location of the receiver. This lookup may be a reverse IP lookup or alternatively a latitude-longitude mapping (e.g. if the user devices are mobile devices). Behaviourally targeted segments are set up in the ad servers (e.g. users in US who have conversed with Brazil, users in Brazil who have conversed with users in the US in the last X days etc.) and users are classified into behaviourally targeted segments. Advertisers can then select content (e.g. advertisements) to users who are classified in a behaviourally targeted segment, which is delivered to users to those users that belong to that behaviourally targeted segment.

At step S616, the selected content is transmitted to Bob responsive to detecting the current activity at the current point in time for outputting to bob via one or more output devices of Bob's user device (e.g. the display, speakers etc.). The selected content constitutes targeted content, targeted at Bob.

FIG. 7 is a schematic illustration of the graphical user interface of Bob's client, by which visual information is presented to Bob on the display 112b of his user device 104b. If the targeted content received at Bob's user device 104b comprises video or image data, the target content is output to Bob by the client 108b via the graphical user interface. As shown in FIG. 7, the targeted content received by Bob is displayed in a portion 706 of the available display area e.g. whilst video of a call is displayed in another portion 708 of the available display area. Thus, in one example, the targeted content may be displayed whilst Bob is on a video call with another user or users (e.g. Alice).

As mentioned, although the above has been described with reference to a server 108 that implements the disclosed methods, in other embodiments the functionality of the server 108 may be implemented by any suitable computer system comprising one or more processors distributed across one or more computer devices.

That is, according to a third aspect a computer system for delivering targeted content to users of a communication system comprises a network interface configured to receive notification data of a communication event conducted over a communication network of the communication system between at least a first and a second user of the communication system, the notification data identifying the second user and conveying information pertaining to the first user. The computer system further comprises one or more processors configured to select content for transmission to the identified second user based on the information pertaining to the first user. The network interface is further configured to transmit the selected content to a user device associated with the identified second user for delivery to the second user.

According to a fourth aspect, a computer system for delivering targeted content to users of a communication system comprises computer storage holding record data of at least one past communication event conducted over a communication network of the communication system, the at least one past communication event between at least a first user and a second user of the communication system. The computer system further comprises one or more processors configured to determine from the record data a historical location of at least one of the first and second users at a past point in time during the past communication event, to select content for transmission to at least the second user based on the determined historical location, and to detect current activity in the communication system by the second user at a current point in time, the current activity at a user device associated with the second user. The computer system further comprises a network interface configured, responsive to detecting the current activity, to transmit the selected content to the user device for delivery to the second user.

A historical location of the first user may be determined, and the content selected is for transmission to the second user based on the determined historical location of the first user. Historical locations of both the first and second users may be determined and the content may be selected based on both the determined historical locations. The step of selecting may be conditional on the second user having communicated with one or more users associated with the determined historical location at least a threshold number of times at past points in time within a considered duration.

According to a fifth aspect, a computer program product comprises executable code stored on a computer-readable medium and configured, when executed, to implement any of the methods disclosed herein.

It will be appreciated that the methods of FIG. 6 is an exemplary configuration of a content selection algorithm based on calling corridors. In general, the algorithm for determining whether content (e.g. an ad) should be targeted to a user who has previously engaged in a conversation of a corridor is configurable. For example, an ad promoting a discounted airfare from New York City to London may be shown to any user in New York City who has sent at least 1 IM to a user/business in the UK in the last 30 days. As another example, the algorithm mat be configured to only show that same ad to users who have sent at least 5 IMs and made at least 3 calls to a user/business in the UK in the last 2 weeks. As another example, the algorithm may be configured to only show that same ad to users who are female and have had at least a 30 minute call with another user in the last 6 months etc.

The manner in which a user is qualified as active across, say, a particular corridor varies depending on the context, and variations will become apparent to the skilled person in view of the present disclosure.

Whilst the above has been described with reference to a packet-based communication network 106 e.g. for effecting Voice or Video over IP (VoIP) calls, IM chats etc., in other embodiments the communication network 106 may not be packet-based and may for example be a PSTN (“Public Switch Telephone Network”). For the avoidance of doubt, it should be noted that “a communication event conducted over a communication network” encompasses communicates that is conducted over multiple networks (e.g. VoIP to PSTN communication events). Thus, the disclosure provides the ability to target content to users based on their prior communications (e.g. communication corridors), regardless of the type of conversation, including landline/mobile phone calls, video calls, VoiceOIP to PSTN, VideoOIP to VideoOIP, PSTN to PSTN) etc.

Generally, any of the functions described herein can be implemented using software, firmware, hardware (e.g., fixed logic circuitry), or a combination of these implementations. The terms “module,” “functionality,” “component” and “logic” as used herein generally represent software, firmware, hardware, or a combination thereof (e.g. the functional blocks of FIG. 5). In the case of a software implementation, the module, functionality, or logic represents program code that performs specified tasks (e.g. the method steps of FIGS. 4, 6A and 6B) when executed on a processor (e.g. CPU or CPUs). The program code can be stored in one or more computer readable memory devices. The features of the techniques described below are platform-independent, meaning that the techniques may be implemented on a variety of commercial computing platforms having a variety of processors.

For example, the user devices may also include an entity (e.g. software such as the client 118) that causes hardware of the user devices to perform operations, e.g., processors functional blocks, and so on. For example, the user devices may include a computer-readable medium that may be configured to maintain instructions that cause the user devices, and more particularly the operating system and associated hardware of the user devices to perform operations. Thus, the instructions function to configure the operating system and associated hardware to perform the operations and in this way result in transformation of the operating system and associated hardware to perform functions. The instructions may be provided by the computer-readable medium to the user devices through a variety of different configurations.

One such configuration of a computer-readable medium is signal bearing medium and thus is configured to transmit the instructions (e.g. as a carrier wave) to the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may us magnetic, optical, and other techniques to store instructions and other data.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method of delivering targeted content to users of a communication system, the method comprising:
receiving notification data of a communication event conducted over a communication network of the communication system between at least a first and a second user of the communication system, the notification data identifying the second user and conveying information pertaining to the first user;
selecting content for transmission to the identified second user based on the information pertaining to the first user; and
transmitting the selected content to a user device associated with the identified second user for delivery to the second user.

2. A method according to claim 1 wherein the notification conveys a geographic location associated with the first user and the content is selected based on that geographic location.

3. A method according to claim 2 wherein the geographic location is a geographic location of the first user at a point in time during the communication event.

4. A method according to claim 1 wherein the notification data comprises a user identifier identifying the first user and the content is selected based on that user identifier.

5. A method according to claim 1 wherein the content is selected based on user data of the first user, wherein at least part of that user data is received in the notification data and/or wherein the notification data identifies a location in computer storage at which at least part of that user data is stored.

6. A method according to claim 5 wherein the user data of the first user comprises location data of the first user and the content is selected based on the location data of the first user, that location data comprising:
a network address of a user device associated with the first user, that network address being mapped within the network to an associated geographic location; and/or
coordinate data explicitly defining a geographic location; and/or
an indication of declared location of the first user as declared by the first user; and/or
a telephone number associated with the first user.

7. A method according to claim 1 wherein the notification data also conveys information pertaining to the second user and the content is selected based on both the information pertaining to the first user and the information pertaining to the second user.

8. A method according to claim 7 wherein the notification data conveys a geographic location associated with the second user and the content is selected based on the information pertaining to the first user and the geographic location associated with the second user.

9. A method according to claim 8 wherein the information pertaining to the first user conveys a geographic location associated with the first user;
wherein the content is stored in association with information conveying an associated target geographical location and an associated interest geographical location; and
wherein the content is selected by matching the geographic location associated with the first user to the interest geographic location and the geographic location associated with the second user to the target geographical location.

10. A method according to claim 5 wherein the user data comprises user model data from a user model of the first user.

11. A method according to claim 10 wherein the user model data of the first user comprises one or more topic identifiers of topics in which the first user has expressed an interest, and the content is selected for transmission to the second user based on at least one of the topic identifiers.

12. A method according to claim 1 wherein the step of selecting content is conditional on the first and second users having participated in communication events with one another at least a threshold number of times at past points in time within a considered duration.

13. A method according to claim 1 wherein the notification data conveys whether or not the second user instigated the communication event, and the content is selected based on whether or not the second user instigated the communication event.

14. A method according to claim 1 wherein the information pertaining to the first user is information about a business entity associated with the first user.

15. A method according to claim 1 wherein the communication event is a call between at least the first and second users and/or an instant messaging communication in which one or more instant messages are transmitted and/or received between at least the first and second users.

16. A computer system for delivering targeted content to users of a communication system, the computer system comprising:
a network interface configured to receive notification data of a communication event conducted over a communication network of the communication system between at least a first and a second user of the communication system, the notification data identifying the second user and conveying information pertaining to the first user; and
one or more processors configured to select content for transmission to the identified second user based on the information pertaining to the first user;
wherein the network interface is further configured to transmit the selected content to a user device associated with the identified second user for delivery to the second user.

17. A computer program product comprising executable code stored on a computer-readable medium configured, when executed, to implement a method of delivering targeted content to users of a communication system, the method comprising:
accessing record data of at least one past communication event conducted over a communication network of the communication system, the at least one past communication event between at least a first user and a second user of the communication system;
determining from the record data a historical location of at least one of the first and second users at a past point in time during the past communication event;
selecting content for transmission to at least the second user based on the determined historical location;
detecting current activity in the communication system by the second user at a current point in time, the current activity at a user device associated with the second user; and
responsive to detecting the current activity, transmitting the selected content to the user device for delivery to the second user.

18. A computer program product according to claim 17 wherein a historical location of the first user is determined, and the content selected is for transmission to the second user based on the determined historical location of the first user.

19. A computer program product according to claim 17 wherein historical locations of both the first and second users are determined and the content is selected based on both the determined historical locations.

20. A computer program product according to claim 17 wherein the step of selecting is conditional on the second user having communicated with one or more users associated with the determined historical location at least a threshold number of times at past points in time within a considered duration.
